(19) United States
(12) Patent Application Publication
(10) Pub. No.: US 2024/0426051 A1
(43) Pub. Date: Dec. 26, 2024

(54) BLADE FOR A REFINER FOR REFINING LIGNOCELLULOSIC MATERIAL, AND REFINER COMPRISING AT LEAST ONE BLADE

(71) Applicant: VALMET AB, Sundsvall (SE)

(72) Inventors: Thommy LINDBLOM, Hägersten (SE); Leonardo GABRIEL, Sundbyberg (SE)

(73) Assignee: VALMET AB, Sundsvall (SE)

(21) Appl. No.: 18/677,342

(22) Filed: May 29, 2024

(30) Foreign Application Priority Data
Jun. 21, 2023 (SE) 2330293-8
Nov. 22, 2023 (SE) 2330519-6

(51) Int. Cl. D21D 1/30

(52) U.S. Cl. CPC D21D 1/303

(57) ABSTRACT

A blade for a refiner for refining of lignocellulosic material includes a blade surface configured to face another blade of the refiner and having a refining portion comprising a plurality of bars and a plurality of dams, each dam extending between two adjacent bars of the plurality of bars. The plurality of dams comprises a first dam extending along a first dam axis, and a second dam extending along a second dam axis. The first dam axis is offset from the second dam axis in a direction along the first bar axis. A first bar comprises a bar section that extends between the first dam axis and the second dam axis. The bar section has a width in a width direction perpendicular to a first bar axis that is larger than a width in the width direction of a remainder of the first bar outside of the bar section.

### CROSS-REFERENCE TO RELATED APPLICATIONS

This application claims priority to Swedish Patent Application No. 2330293-8, filed on Jun. 21, 2023, and Swedish Patent Application No. 2330519-6, filed on Nov. 22, 2023. The entire contents of these applications are hereby incorporated by reference.

The present patent disclosure relates to blades for a refiner for refining lignocellulosic material during production of pulp, and to such refiners.

A refiner, or disc refiner, is commonly used within the pulping industry for refining lignocellulosic material used in the production of fibrous material such as paper and board.

The disc refiner comprises two or more opposite refining elements, at least one of which is rotatable. The rotating refining element can be referred to as a rotor or a rotor side blade, whereas the non-rotating or stationary refining element can be referred to as a stator or a stator side blade. Between the refining elements is a refining gap, where the material to be refined is ground against the refining surfaces. The refining surface of the refining elements comprises refiner bars that serve to refine the lignocellulosic material during use, and also comprises dams that intersect the refiner bars and lift the lignocellulosic material towards the refining gap to ensure a thorough refining.

Refining lignocellulosic material is costly since the energy consumption to reach the desired fiber quality is typically very high. There are some suggested improvements within this area, but further developments are needed to ensure the desired fiber quality while at the same time providing a more energy efficient refiner blade. Also, refiner blades suffer from wear during use and must be replaced periodically, which period lies in the order of several days up to months, depending on the lignocellulosic material and conditions. During a blade replacement the refiner is offline and such a replacement is thus inefficient and costly.

It is an object, among objects, of the present disclosure to eliminate or at least to reduce the problems discussed above. This is achieved by a blade for a refiner and by a refiner comprising such a blade according to the appended respective independent claims.

In the present disclosure, in accordance with a first aspect, there is provided a blade for a refiner for refining of lignocellulosic material, the blade comprising a blade surface configured to face another blade of the refiner and delimited by an inner periphery and an outer periphery, wherein the blade surface has a refining portion comprising a plurality of bars protruding from the blade surface, wherein each of the plurality of bars extends at least partially along a respective bar axis of a plurality of bar axes, wherein each respective bar axis extends from the inner periphery towards the outer periphery, wherein the plurality of bars comprises a first bar extending along a first bar axis of the plurality of bar axes; and a plurality of dams, each dam extending along a respective dam axis of a plurality of dam axes and between two adjacent bars of the plurality of bars, wherein the plurality of dams comprises a first dam extending along a first dam axis, and a second dam extending along a second dam axis, wherein the first dam axis is offset from the second dam axis in a direction along the first bar axis, wherein the first dam extends from a first lateral side of the first bar to a first neighbouring bar among the plurality of bars and the second dam extends from a second lateral side of the first bar opposite the first lateral side to a second neighbouring bar among the plurality of bars, wherein the first dam is closest to the outer periphery among one or more dams extending from the first bar to the first neighbouring bar, wherein the second dam is closest to the outer periphery among one or more dams extending from the first bar to the second neighbouring bar, wherein the first bar comprises a bar section that extends between the first dam axis and the second dam axis, characterized in that the bar section has a width in a width direction perpendicular to the first bar axis that is larger than a width in the width direction of a remainder of the first bar outside of the bar section.

The blade according to the present patent disclosure comprises the bar section between the first and second dams that is thicker than the remainder of the bar. The bar section is a boundary section between the high pressure within the refiner, and the low pressure outside the refiner. It is found that the thickening of the bar section beneficially results in a prolongated lifetime of the blade, while having no or only a limited impact on the refining performance.

In an embodiment, the plurality of bars comprises one or more sets of bars, each set of bars comprising the first bar, the first neighbouring bar, and the second neighbouring bar.

In an embodiment, the plurality of bars and the plurality of dams are disposed in a number of pattern areas, wherein the pattern areas are positioned side by side with each other to cover at least a part of the blade surface. The pattern areas may have differing orientations. The bar axes and/or dam axes of a first pattern area may have respective orientations that are different from respective orientations of bar axes and/or dam axes of a second pattern area neighbouring the first pattern area.

In an embodiment, each of the pattern areas comprises one or more of the one or more sets of bars.

In an embodiment, the sets of bars overlap with each other such that the first neighbouring bar of a first set of the one or sets of bars is also the first bar of a second set of the one or more sets of bars.

In an embodiment, the first neighbouring bar of the first set of the one or sets of bars is also the second neighbouring bar of the second set of the one or more sets of bars.

In an embodiment, the second neighbouring bar of the first set of the one or sets of bars is also the first bar of the second set of the one or more sets of bars.

In an embodiment, the second neighbouring bar of the first set of the one or sets of bars is also the first neighbouring bar of the second set of the one or more sets of bars.

In an embodiment, the first bar of the first set of the one or sets of bars is also the first neighbouring bar of the second set of the one or more sets of bars.

In an embodiment, the first bar of the first set of the one or sets of bars is also the second neighbouring bar of the second set of the one or more sets of bars.

In an embodiment, the sets of bars are adjacent to each other.

In an embodiment, the number of pattern areas comprise: a first pattern area of bars and dams; a second pattern area of bars and dams, wherein an orientation of the second pattern area is different from an orientation of the first pattern area, wherein the first and second pattern areas are positioned side by side with respect to each other to cover at least a part of the refining surface; and one or more connecting bars and/or connecting dams connecting the respective bars and/or dams of the first pattern area and the second pattern area, wherein the sets of bars of the first pattern area do not overlap with the sets of bars of the second pattern area. In other words, the widened bar sections are comprised within a pattern area. The widened bar sections may not be sections of the connecting bars that connect two pattern sections.

In an embodiment, the plurality of bars is arranged such that a movement along the plurality of bar axes from the outer periphery to the inner periphery also a movement in a first circumferential direction. This causes the lignocellulosic material to be pushed in an outward direction towards the outer periphery when the blade is in use in the refiner during refining.

In an embodiment, the plurality of dams is arranged such that a movement along respective dam axes of the plurality of dams from the inner periphery to the outer periphery is also a movement in the first circumferential direction, the plurality of dam axes comprising the first dam axis and the second dam axis.

In an embodiment, the plurality of dams is arranged such that a movement along respective dam axes of the plurality of dams from the outer periphery to the inner periphery is also a movement in the first circumferential direction, the plurality of dam axes comprising the first dam axis and the second dam axis.

In an embodiment, the first dam is closer to the outer periphery than the second dam.

In an embodiment, the second dam is closer to the outer periphery than the first dam.

In an embodiment, the bar section comprises a first lateral edge and a second lateral edge opposite the first lateral edge, wherein the first lateral edge is at least partially offset compared to a corresponding lateral edge of the remainder of the first bar relative to the first bar axis; or the second lateral edge is at least partially offset compared to a corresponding second lateral edge of the remainder of the first bar relative to the first bar axis.

In an embodiment, the first dam extends from the first lateral edge; the second dam extends from the second lateral edge; when the first lateral edge is offset, the second dam is closer to the outer periphery than the first dam; and when the second lateral edge is offset, the first dam is closer to the outer periphery than the second dam.

In an embodiment, the bar section has a triangular shape when viewed from a direction perpendicular to the blade.

In an embodiment, the bar section comprises an inner end nearest the inner periphery and an outer end nearest the outer periphery, wherein the width of the bar section is larger at the inner end than the width of the bar section at the outer end.

In an embodiment, the bar section has a rectangular shape when viewed from a direction perpendicular to the blade.

In an embodiment, the bar section has one of a broken angle shape, a concave arc shape, a convex arc shape, a concave shape, and a convex shape when viewed from a direction perpendicular to the blade.

In an embodiment, each of the plurality of bar axes does not cross with another bar axis of the plurality of bar axes within the refining portion.

In an embodiment, each the plurality of dam axes does not cross with another dam axis of the plurality of dam axes within the refining portion.

According to some embodiments, each dam has a dam height that is substantially equal to a bar height of at least one of the bars that the dam intersects. This ensures that the dam is able to lift the lignocellulosic material to the refining gap to improve the refining quality.

According to other embodiments, each dam has a dam height that is 20-99%, preferably 20-85% of a bar height of at least one of the refiner bars that said dam connects. Thereby, a subsurface dam is achieved that enables a flow of steam and also improves the flow of material across the dam.

In some embodiments, the blade comprises the dam with a dam height that is substantially equal to the bar height, and also comprises at least one dam with a dam height that is 20-99%, preferably 20-85% of a bar height of at least one of the refiner bars that said dam connects. Thereby, dams and subsurface dams can be combined as desired to improve the flow of lignocellulosic material and steam while at the same time enabling a high quality of refining.

Suitably, the blade may also comprise a groove extending adjacent to the dam on a side of the dam facing the outer periphery. Thereby, a pumping transport of lignocellulosic material is enabled, where the material after passing over the dam can flow along the groove before entering a bar groove between refiner bars for further transport towards the outer periphery. This in turn improves energy efficiency and decreases wear of the refiner blade.

The groove may have a width that increases towards the inner dam end. Thereby, the lignocellulosic material is encouraged to enter the bar grooves as it passes along the groove.

Also, the groove may suitably have a width at an upper end that is at least equal to a width of the dam. Thereby, the groove is wide enough that the flow of lignocellulosic material is improved. The width at the upper end is a distance from the outer side of the dam in the radial direction to a refiner bar at a point where the refiner bar starts to taper towards the blade surface.

Suitably, the groove may have a depth that is at least equal to half the dam height of the dam adjacent the groove. Thereby, the groove is deep enough that the flow of lignocellulosic material is improved.

Suitably, the blade may also comprise a reinforcement portion where the outer dam end is connected to a refiner bar, said reinforcement portion being arranged on the side of the dam facing the inner periphery. Thereby, wear is decreased so that the lifetime of the blade is further increased.

Suitably, the outer dam end of a first dam and the outer dam end of an adjacent dam in a radial direction may each be connected to different refiner bars in the first circumferential direction. Thereby, the dams have an overlap in the radial direction and this increases strength of the blade and distributes areas subjected to large wear across the blade to render the blade as a whole more robust.

In some embodiments, the blade is a blade portion having a central angle of 10-360°. Where the blade is not circular, the blade portion may then be combined with a plurality of similar or identical blade portions to form a circular blade.

Also, there may be at least one portion lacking refiner bars. Thereby, lignocellulosic material may be transported across the blade without being refined except in the refiner portion.

According to a second aspect, there is provided a refiner comprising at least one blade according to any one or more embodiments of the blade according to the first aspect described above and/or below.

Many additional benefits and advantages of the present patent disclosure will be readily understood by the skilled person in view of the detailed description below.

### BRIEF DESCRIPTION OF FIGURES

The patent disclosure will now be described in more detail with reference to the appended figures, in which:

FIG. 1 is a schematic illustration of the cross-section of a refiner in which the refiner disc according to the present patent disclosure may be used;

FIG. 2 is a schematic illustration in planar view from above of a blade according to an embodiment of the present patent disclosure;

FIG. 3 is a schematic illustration in planar view from above of a set of bars of a blade according to an embodiment of the present patent disclosure;

FIG. 4 is a schematic illustration in planar view from above of a set of bars of a blade according to an embodiment of the present patent disclosure;

FIG. 5 is a schematic illustration in planar view from above of two overlapping set of bars of a blade according to an embodiment of the present patent disclosure;

FIG. 6 is a schematic illustration in planar view from above of a set of bars of a blade according to an embodiment of the present patent disclosure;

FIG. 7 is a schematic illustration in planar view from above of a set of bars of a blade according to an embodiment of the present patent disclosure;

FIG. 8 is a schematic illustration in planar view from above of a set of bars of a blade according to an embodiment of the present patent disclosure;

FIG. 9 is a schematic illustration in planar view from above of a set of bars of a blade according to an embodiment of the present patent disclosure;

FIG. 10 is a schematic illustration in planar view from above of a set of bars of a blade according to an embodiment of the present patent disclosure;

FIG. 11 is a schematic illustration in planar view from above of a set of bars of a blade according to an embodiment of the present patent disclosure;

FIG. 12 is a schematic illustration in planar view from above of a set of bars of a blade according to an embodiment of the present patent disclosure;

FIG. 13 is a schematic illustration in planar view from above of a set of bars of a blade according to an embodiment of the present patent disclosure; and

FIG. 14 is a schematic illustration in planar view from above of a blade according to another embodiment of the present patent disclosure.

All the figures are schematic, not necessarily to scale, and generally only show parts which are helpful to elucidate the respective embodiments, whereas other parts may be omitted or merely suggested. Any reference number appearing in multiple drawings refers to the same object or feature throughout the drawings, unless otherwise indicated.

### DETAILED DESCRIPTION

Reference is made to FIG. 1 which schematically illustrates a refiner that can utilize the patent disclosure. FIG. 1 shows schematically pulp refiner 1 in a cross-sectional view. Examples of components not shown are an electrical motor for driving e.g. the rotation shaft, the feeding mechanism for the lignocellulosic material etc. A rotor refiner disc 36 and a stator refiner disc 36* are linearly aligned along a shaft (not shown). The rotor refiner disc 36 may be attached to a rotation shaft arranged on bearings. The rotation shaft may be connected to a motor, not shown, that rotates the shaft, and thus the rotor refiner disc 36. The stator refiner disc 36* facing the rotor refiner disc 36 can be provided with a centrally located through hole 38 that extends between a feeding channel for lignocellulosic material and a refining area 19. The feeding of material into the refining area 19 need not necessarily be provided via a centrally located through hole as shown in FIG. 1, but can instead be distributed via through holes distributed in another way than centrally. The rotor refiner disc 36 can in certain embodiments be provided with a centre plate 16 having a surface facing the incoming flow of lignocellulosic material. The surface of the centre plate 16 can be provided with structures that will direct the lignocellulosic material outwards. The rotor refiner disc 36* and/or the stator refiner disc 36 are provided with refiner blades 10 to enable steering and grinding of the pulp. These refiner blades 10 can be provided with bars and dams which will be described in more detail below. In some refiners there may be two rotor refiner discs instead of a rotor and a stator refiner disc, where the two rotor refiner discs are rotated in opposite directions. The present patent disclosure can be applied also in such refiners.

During use, lignocellulosic material such as wood chips or prepared wood, e.g., pulp, will be fed by means of a feeding mechanism, such as a screw feeder, not shown, through the feeding channel. The material will pass through the hole 38 in the stator refiner disc 36* and enter an area 19. The area 19 is essentially defined by the open area between the rotor 30 and the stator refiner disc 36* and this area can be quite small during operation. The lignocellulosic material flowing into the area 19 will be incident on the centre plate 16 on the rotor refiner disc 36. The centre plate 16 acts to steer the lignocellulosic material out towards the refiner blades 10 on the rotor and/or stator refiner disc.

The term lignocellulosic material is used herein to mean materials comprising cellulose and preferably also comprising lignin and hemicellulose. One example of such materials is wood, others include other agricultural or forestry wastes. When refining lignocellulosic material Lignocellulosic material may also refer to materials containing mainly cellulose, such as e.g. cotton.

The rotor refiner disc 36 is provided, on the surface facing the stator refiner disc 36*, with at least one refiner blade 10. The stator refiner disc 36* may also be provided, on the surface facing the rotor refiner disc 36, with at least one refiner blade 10. These refiner blades 10 provided on the rotor refiner disc 36 and the stator refiner disc 36* respectively may or may not be equally designed. The refiner blade according to the present patent disclosure may be provided to either one or both of the rotor and stator refiner discs 36, 36* or one or both of two rotor refiner discs in the case of two rotating discs. The rotor and stator refiner discs may in certain versions of a refiner be referred to as segment holders since one of the purposes of the refiner discs are to carry refiner blades 1.

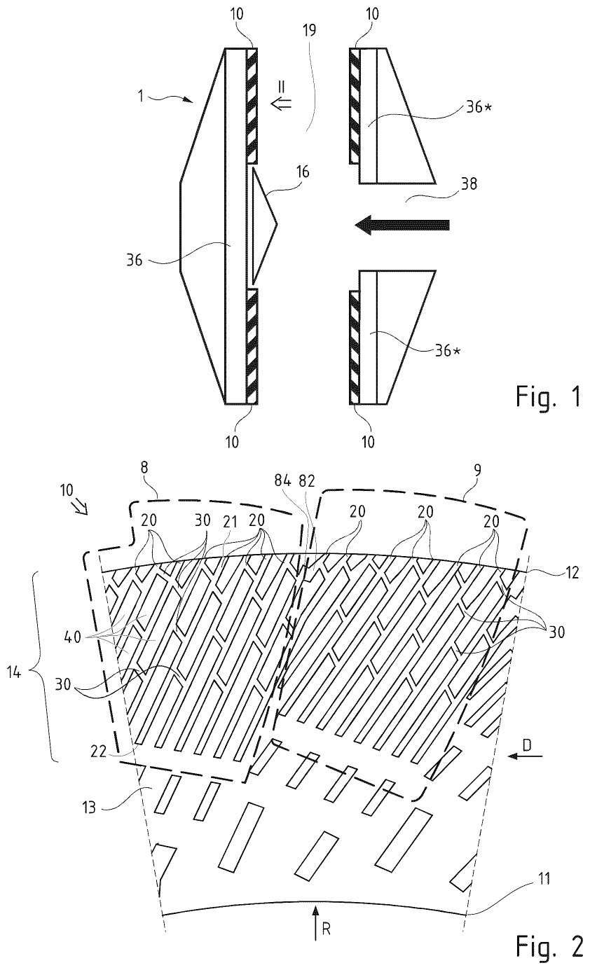

A general refiner 1 that can utilize the patent disclosure has now been described above in relation to FIG. 1. FIG. 2 provides a schematic illustration of an example of a refiner blade 1 according to the present patent disclosure. The refiner blade 1 is to be provided to a refiner disc 36. This can be both a rotor refiner disc 36 and a stator refiner disc 36* but will only be referred to as refiner disc 36 hereafter. The refiner blade 1 consists in this particular example of a circular sector. There are other versions of refiner blades, the patent disclosure however functions equally well for all particular refiner blade shapes. The refiner blade 1 is provided in the shape of a segment to be attached to a refiner disc 36. A refiner blade 1 may be provided in the shape of a circle, optionally with a removed central area for leaving room for a centre plate 16 or an inlet 38 as described above. A refiner blade I may also be provided in the shape of a sector of a circle where the circle optionally has a removed central area or in the shape of another part of a circle. A refiner disc 36 may thus be provided with a number of refiner blades 1 whereby it will either be completely covered by refiner blades 1 or partially covered. In case the refiner blade 10 forms part of a rotor refiner disc 36, the centre area of the rotor refiner disc may comprise a centre plate 16 as described above.

FIG. 2 shows a blade 10 according to a first embodiment of the present patent disclosure. The blade 10 shown in the Figures according to any embodiment of the present patent disclosure may be a part of a circular blade of which only a portion is shown or may alternatively be a blade segment that is configured to be mounted together with a plurality of similar blade segments to form a circular blade.

As described above, when in use, the blade 10 is generally mounted in a disc refiner, such as the refiner 1, and serves to refine lignocellulosic material by acting as a blade within a blade pair that are arranged to face each other, wherein at least one of the blades in the pair is arranged to rotate. Generally, a blade that is arranged to rotate in the disc refiner is referred to as a rotor side blade, whereas a blade that is arranged to be stationary is referred to as a stator side blade. When in use, a refiner gap is formed between the blades so that lignocellulosic material passing through the refiner gap is refined by refiner bars arranged on each of the blades.

This patent disclosure describes various embodiments, and it is in particular to be noted that a feature from one embodiment may freely be introduced into another embodiment except where such a combination is explicitly stated as unsuitable or undesirable. Thus, the embodiments disclosed herein may be combined with each other as desired.

It is to be noted that each of the embodiments shown in the Figures may be only a portion of a blade 10 and that the blade 10 itself may comprise additional portions at the inner periphery 11, and on either sides of that shown in each Figure. Thus, the Figures are to be seen as embodiments having a pattern of refiner bars and dams that can be repeated across the entire blade 10 or that can be provided in only one portion of said blade 10.

The blade 10 shown in FIG. 2 is delimited by an inner periphery 11 and an outer periphery 12 and comprises a blade surface 13. On the blade surface 13 is at least one refiner portion 14 comprising a plurality of refiner bars 20 that extend outwards from the blade surface 13. The refiner portion 14 may extend across the entire blade surface 13 but in most embodiments the blade surface 13 also comprises other portions that do not include refiner bars 20. In FIG. 2, the blade 10 is shown with a portion near the inner periphery 11 lacking refiner bars 20, and this may also be provided in other parts of the blade surface 13.

The refiner bars 20 each comprise an outer bar end 21 and an inner bar end 22, wherein the outer bar end 21 is closer to the outer periphery 12 than the inner bar end 22. The refiner bars 20 are arranged so that a movement along a bar extension, i.e. a movement along an individual refiner bar 20, from the outer bar end 21 to the inner bar end 22 is also a movement in a first circumferential direction D. The first circumferential direction D is a rotational direction when the blade 10 is arranged in the refiner, and the first rotational direction D is further perpendicular to a radial direction R that is defined as a direction from a point on the inner periphery 11 to a point on the outer periphery 12 that is closest to the point on the inner periphery 11. That the movement along the bar extension is a movement in the first circumferential direction D is to be understood herein as the movement having a component that is directed in the first circumferential direction D. There may also be a component that is in a radial direction perpendicular to the first circumferential direction D.

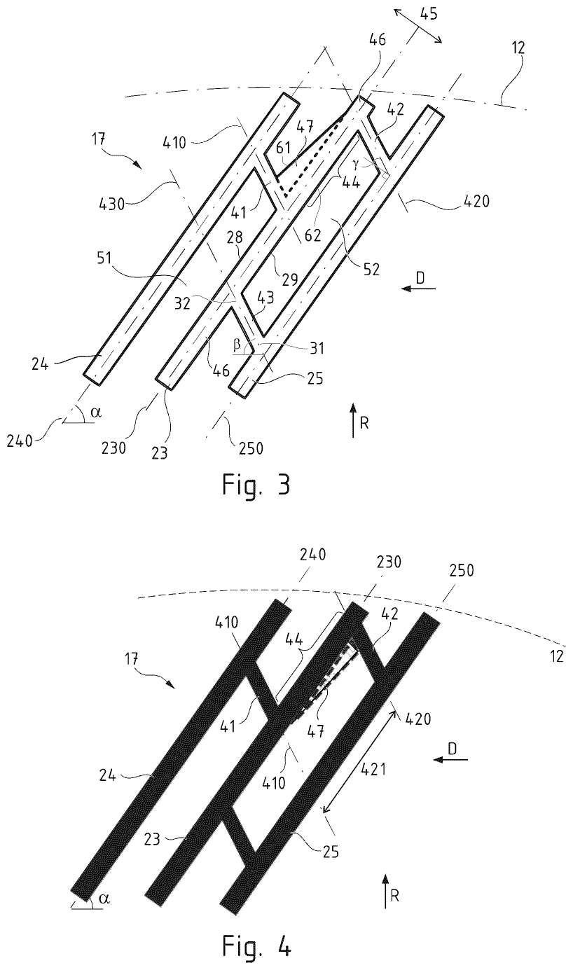

Each of the plurality of bars 20 extends at least partially along a respective bar axis of a plurality of bar axes 230, 240, 250 (FIG. 3). Each respective bar axis extends from the inner periphery 11 towards the outer periphery 12. The plurality of bars 20 comprises a first bar 23 extending along a first bar axis 230 of the plurality of bar axes, a first neighbouring bar or second bar 24 extending along a second bar axis 240, and a second neighbouring bar or third bar 25 extending along a third bar axis 250.

Each dam extends along a respective dam axis of a plurality of dam axes 410, 420 and between two adjacent bars of the plurality of bars 20. The plurality of dams 30 comprises a first dam 41 extending along a first dam axis 410, and a second dam 42 extending along a second dam axis 420, wherein the first dam axis 410 is offset by offset 421 from the second dam axis 420 in a direction along the first bar axis 230. The first dam 41 extends from a first lateral side 28 of the first bar 23 to the first neighbouring bar 24. The second dam 42 extends from a second lateral side 29 of the first bar 21 opposite the first lateral side 28 to the second neighbouring bar 25.

The first dam 41 is closest to the outer periphery 12 among one or more dams 30 extending from the first bar 23 to the first neighbouring bar 24. The second dam 42 is closest to the outer periphery 12 among one or more dams 30 extending from the first bar 23 to the second neighbouring bar 25.

The first bar 23 comprises a bar section 44 that extends between the first dam axis 410 and the second dam axis 420. The bar section is a boundary section between the high pressure within the refiner, and the low pressure outside the refiner. The bar section 44 has a width in a width direction 45 perpendicular to the first bar axis 230 that is larger than a width in the width direction 45 of a remainder 46 of the first bar 23 outside of the bar section 44. The first bar 23 thus comprises an additional lateral portion 47 in the bar section 44. The lateral portion 47 in FIG. 3 is present at the first lateral side 28, which in the example of FIG. 3 is at an outer side the first dam 41, towards to the outer periphery 12. In terms of the lignocellulosic material flow, the lateral portion 47 is in a downstream side of the first bar 23 in FIG. 2.

Alternatively, and as shown in FIG. 4, the lateral portion 47 may be at the second lateral side 29 of the first bar 23. In terms of the lignocellulosic material flow, the lateral portion 47 is in an upstream side of the first bar 23 in FIG. 3.

It is noted that while FIGS. 2, 3, 15 and 16 show the bars 20 and dams 30 drawn with contours, while FIGS. 3 to 14 show the bars 20 and dams 30 drawn in solid black, this difference in drawing style has no technical meaning but is merely used for the ease of understanding the various embodiments described herein, unless mentioned otherwise.

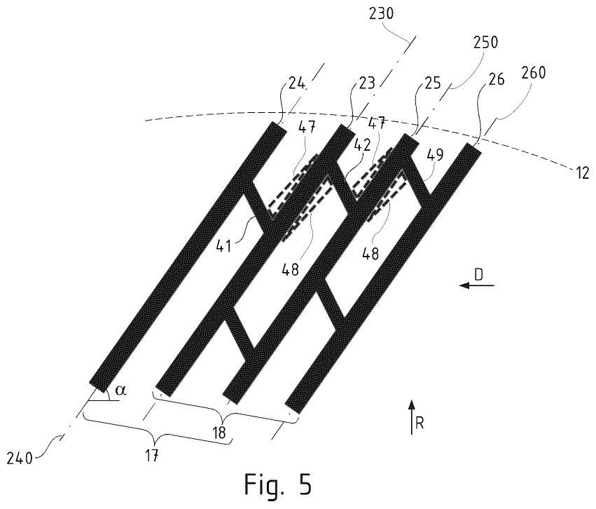

Yet another alternative is that the first bar 23 comprises a first lateral portion 47 at the first lateral side 28 and a second lateral portion 48 at the second lateral side 29. In other words, both at the downstream and upstream side of the first bar 23. Examples of this configuration are shown in FIGS. 5 to 15. The embodiments of FIGS. 5 to 15 show both the first 47 and second 48 lateral portions, but may have only one of these lateral portions. These FIGS. 5 to 15 serve to show other configurations and are not limited to having both the lateral portions.

The bar section 44 may comprise a first lateral edge 61 and a second lateral edge 62 opposite the first lateral edge 61. The first lateral edge 61 may be at least partially offset compared to a corresponding lateral edge of the remainder 46 of the first bar 23 relative to the first bar axis 230. Alternatively, the second lateral edge 62 is at least partially offset compared to a corresponding second lateral edge of the remainder 46 of the first bar 23 relative to the first bar axis 230.

The first dam 41 may extend from the first lateral edge 61. The second dam 42 may extend from the second lateral edge 62.

When the additional portion 47 is at the downstream side of the first bar and the first lateral edge 61 is offset, the second dam 42 is closer to the outer periphery 12 than the first dam 41.

When the additional portion 47 is at the upstream side of the first bar and the second lateral edge 62 is offset, the second dam 42 is closer to the outer periphery 12 than the first dam 41. When the additional portion 47 is at the upstream side and the first lateral edge 61 is offset, the first dam 41 is closer to the outer periphery 12 than the second dam 42.

The plurality of bars 20 may comprise one or more sets 17, 18 of bars (FIG. 5), each set of bars comprising the first bar 23, the first neighbouring bar 24, and the second neighbouring bar 25.

The plurality of bars 20 and the plurality of dams 11 may be disposed in a number of pattern areas 8, 9 (FIG. 1). The pattern areas 8, 9 are positioned side by side with each other to cover at least a part of the blade surface 10. Each of the pattern areas 8, 9 comprises one or more of the one or more sets 17 of bars.

The sets 17, 18 of bars may overlap with each other such that the first neighbouring bar 24 of a first set 17 of bars is also the first bar of a second set 18 of bars, as is indicated in FIG. 5. The first set 17 comprises bar 23 as the first bar, bar 24 (or bar 25) as the first neighbouring bar and bar 25 (or bar 24) as the second neighbouring bar. The second set 18 comprises bar 25 as the first bar, bar 23 (or bar 26) as the first neighbouring bar, and bar 26 (or bar 23) as the second neighbouring bar. This configuration of the sets is the result of each outermost dam being offset relative to the next outermost dam. In those cases, the first bar comprises the first lateral portion 47 or the second lateral portion 48 or both.

Bar 26 extends along bar axis 260. Dam 49 extends between bar 25 and bar 26. Dam 49 is another example of dams that are closest to the outer periphery 12, in this case among dams extending from the bar 25 to the bar 25, wherein bar 25 can be seen as the first neighbouring bar for bar 26.

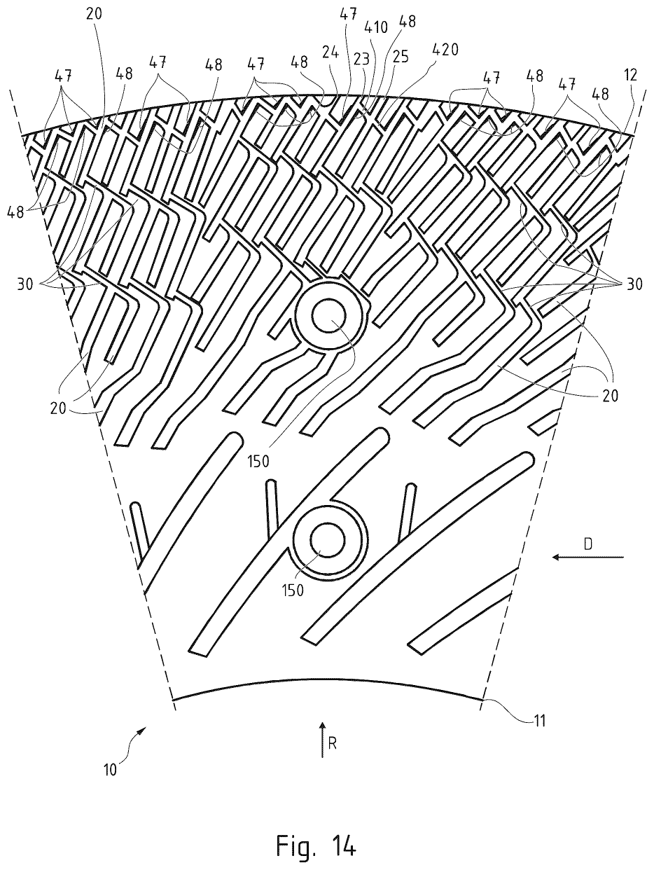

The second set 18 could, alternative to FIG. 5, comprise bar 26 as its first bar, with bar 25 being either the first or second neighbouring bar, and the other neighbouring bar not shown within FIG. 5 but this bar would be towards the right of bar 26 in this case. This configuration is the result of two outer most dams extending from opposite sides of a bar 20 being arranged without an offset. An example of this is shown in FIG. 14, with the dams marked with 410 and 420 having no offset in a direction along the bar 25 relative to each other. In other words, dams 410 and 420 substantially align. Therefore, there is no widening of bar 25 in that case.

Alternatively, the sets of bars are adjacent to each other, that is, without the bars being part of more than one set of three bars. This configuration is the result of at least three adjacent outer most dams being substantially aligned.

The number of pattern areas 8, 9 may comprise a first pattern area 8 of bars and dams and a second pattern area 9 of bars and dams (FIG. 1). An orientation of the second pattern area 9 is different from an orientation of the first pattern area 8. The first 8 and second 9 pattern areas are positioned side by side with respect to each other to cover at least a part of the refining surface 14. The respective angles (α) of the dams of each pattern are different. In pattern 9 of FIG. 1 the angle of the bars 20 relative to the rotational direction D in the clockwise direction is smaller than the angle of the bars 20 relative to the rotational direction D in the clockwise direction of pattern 8.

Between each pattern there may be provided one or more connecting bars 82 and/or connecting dams 84 connecting the respective bars and/or dams of the first pattern area 8 and the second pattern area 9. The sets of bars of the first pattern area 8 may not overlap with the sets of bars of the second pattern area 9.

The first dam 41 may be closer to the outer periphery 12 than the second dam 42. Alternatively, the second dam 42 may be closer to the outer periphery 12 than the first dam 41. This configuration is shown in, among others, FIGS. 3, 4 and 5.

The bar section 44, the additional portion 47 and/or additional portion 48 may have varying shapes. As shown in FIGS. 1 to 5, the bar section 44 may have a triangular shape when viewed from a direction perpendicular to the blade 10. The bar section 44 may comprise an inner end 54 nearest the inner periphery 11 and an outer end 55 nearest the outer periphery 12, wherein the width of the bar section 10 is larger at the inner end 54 than the width of the bar section 10 at the outer end 55. In this way, a triangular shape may be formed, in particular when the first lateral edge 61 or the second lateral edge 62, whichever is offset, is formed straight.

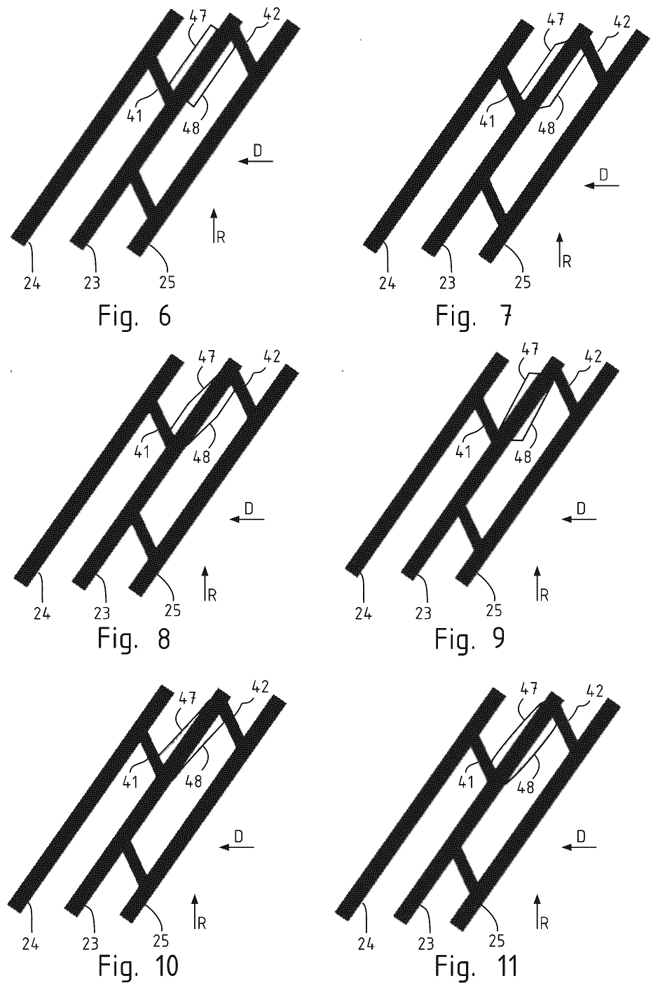

As shown in FIG. 6, the bar section 44, the additional portion 47 and/or additional portion 48 may have a rectangular shape when viewed from a direction perpendicular to the blade 10.

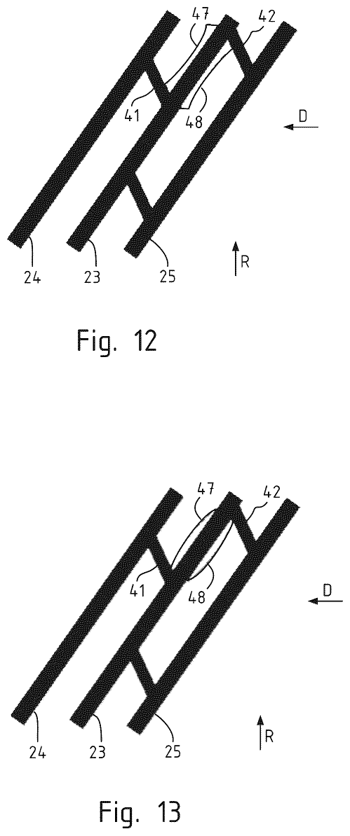

Alternatively, the bar section 44, the additional portion 47 and/or additional portion 48 may have of a broken angle shape (FIGS. 7, 8, and 9), a concave arc shape (FIG. 10), a convex arc shape (FIG. 11), a concave shape (FIG. 12), and a convex shape (FIG. 13) when viewed from a direction perpendicular to the blade 10.

The shapes of the first additional portion 47 and the second additional portion 48 may be the same or different.

In general, each of the plurality of bar axes 230, 240, 250 may not cross with another bar axis of the plurality of bar axes 230, 240, 250 within the refining portion 14. Additionally, or alternatively, each the plurality of dam axes 410, 420 may not cross with another dam axis of the plurality of dam axes 410, 420 within the refining portion 14.

The arrangement of the refiner bars 20 is such that the refiner bars 20 are inclined with respect to the radial direction R to form a bar angle α (FIG. 4) in a clockwise direction that is less than 90°. In some embodiments, the refiner bars 20 are parallel to each other but in other embodiments at least one of them may be non-parallel to the others. Also, the refiner bars in some embodiments form straight lines but may in some embodiments be curved. Also, in some embodiments the refiner bars 20 may vary across the blade 10 so that some of them form straight lines while others are curved, and that some of them are parallel but others are not. At the inner bar end 22, the bars 20 preferably taper to the blade surface 13. The bar angle α may differ for each refiner bar 20, but may advantageously lie in the range of 5°-60°.

Also provided on the refiner portion 14 is at least one dam 30 that connects at least two refiner bars 20. Each dam 30 extends from an outer dam end 31 to an inner dam end 32 (FIG. 3), wherein the outer dam end 31 is closer to the outer periphery 12 than the inner dam end 32. In the embodiment of FIG. 2, the dam 30 is further arranged so that a movement along a dam extension, i.e. a movement along the individual dam 30, from the inner dam end 32 to the outer dam end 31 is also a movement in the first circumferential direction D. This means that the dam 30 is inclined with respect to the radial direction R to form a dam angle in the counterclockwise direction that is less than 90°. The dam angle β may differ for each of the dams 30 but may advantageously lie in the range of 30-85°. In embodiments where the dam 30 is curved, the dam angle β may suitably decrease when moving from the outer dam end 31 towards the inner dam end 32.

Where the dam 30 is connected to a refiner bar 20, a connection angle γ is formed in a corner facing in the first circumferential direction D and facing the inner periphery 11. The connection angle γ may advantageously lie in the range 30°-85°, which ensures an efficient refining of lignocellulosic material as well as a lowered energy consumption.

The bar angle α may vary across the segment. It is advantageous to provide a larger bar angle α towards the center of the blade 10, i.e. towards the inner periphery 11 but to provide a smaller bar angle α when the bars are closer to the outer periphery 12. Also, the dam angle β may vary across the segment and it is advantageous to provide a smaller dam angle β near the inner periphery 11 but a larger dam angle β near the outer periphery 12. Thus, when moving across the blade 10 in the radial direction R from the inner periphery 11 to the outer periphery 12, the bar angle α may decrease whereas the dam angle β may increase.

The dams 30 shown in FIG. 2 are provided so that two refiner bars 20 are connected by more than one dam 30 of which the dams 30 are arranged along the same refiner bars 20 but at different distances to the inner periphery 11. In other embodiments, the dams 30 may instead be arranged so that only some of the refiner bars 20 connected by one dam 30 are connected by another dam 30 closer to the inner periphery 11, or so that each refiner bar 20 is connected to only one dam 30 at each lateral side of the respective refiner bar 20.

The dams 30 may each form straight lines or curves, and they may be parallel or non-parallel to each other as desired.

The arrangement of the bars 20 with their inner bar end 22 further along in the first circumferential direction D than the outer bar end 21 means that the bars 20 are able to raise the lignocellulosic material from bar grooves 40 into the refining gap to improve refining while at the same time enabling efficient transport of the lignocellulosic material across the blade 10 from the inner periphery 11 to the outer periphery 12. Examples of grooves 40 are shown in FIG. 3 as groove 51 and groove 52. Groove 51 is arranged adjacent to dam 41 at an inner periphery side thereof, and between the first bar 23 and the first neighbouring bar 24. Groove 52 is arranged adjacent to dam 42 at an inner periphery side thereof, and between the first bar 23 and the second neighbouring bar 25. Groove 52 is further delimited by dam 43, which is a second outermost dam relative to dam 42.

In the embodiment of FIG. 2, the dams 30 has a dam height that is preferably substantially equal to a bar height of the one or more respective bars 20 that the dam 30 intersects. This means that the dam 30 lifts the cellulosic material all the way to the refining gap and prevents a flow of lignocellulosic material across the dam 30 that is not refined by the refiner bars 20. That the dam height is substantially equal to the bar height is to be understood as them being equal within manufacturing tolerances or at least not differing from each other more than 10% of their height from the blade surface 13. In the first embodiment, all the dams 30 have this dam height, but in other embodiments at least one of them could be lower. The dam height being substantially equal to a bar height is also advantageous in increasing pressure between the blades during refining.

The embodiment of blade 10 shown in FIG. 14 comprises mounting holes 150 for mounting the blade 10, which may be a blade segment.

As mentioned above, the blade 10 may be a circular blade but it may alternatively be a blade portion having a central angle of 10°-360°. A plurality of blade portions can then be mounted in a refiner to form a circular blade.

The refiner portion 14 may extend across the entire blade surface 13 from the inner periphery 11 to the outer periphery 12. Alternatively, there may be other portions on the blade surface 13, such as the outer portion 15 disclosed above and in FIG. 5. There may also be such portions comprising refiner bars that are arranged between the refiner portion 14 and the inner periphery 11. Also, there may be at least one portion on the blade surface 13 that lacks refiner bars, and such a portion may be arranged close to the inner periphery 11, close to the outer periphery 12, or at any other part of the blade surface 13.

Also, in some embodiments there may be two or more refiner portions 14 according to the present patent disclosure on the blade surface 13 with another portion either comprising refiner bars or lacking refiner bars between them.

The present patent disclosure also relates to a refiner that comprises at least one blade 10 according to any embodiment of the patent disclosure as disclosed herein. Said refiner may in some embodiments comprise two blades 10 according to the patent disclosure, with one of them arranged as the rotor side blade and the other as the stator side blade. In other embodiments, one blade 10 according to the patent disclosure may be arranged together with a refiner blade according to the prior art as either the rotor side blade or the stator side blade.

It is to be noted that features from the various embodiments described herein may freely be combined, unless it is explicitly stated that such a combination would be unsuitable.

1. A blade for a refiner for refining lignocellulosic material, the blade comprising:
a blade surface configured to face another blade of the refiner, wherein the blade is delimited by an inner periphery and an outer periphery, and wherein the blade surface has a refining portion comprising:
a plurality of bars protruding from the blade surface, wherein each of the plurality of bars extends at least partially along a respective bar axis of a plurality of bar axes, wherein each respective bar axis extends from the inner periphery towards the outer periphery, wherein the plurality of bars comprises a first bar extending along a first bar axis of the plurality of bar axes, and
a plurality of dams, each dam extending along a respective dam axis of a plurality of dam axes and between two adjacent bars of the plurality of bars, wherein the plurality of dams comprises a first dam extending along a first dam axis, and a second dam extending along a second dam axis, wherein the first dam axis is offset from the second dam axis in a direction along the first bar axis,
wherein the first dam extends from a first lateral side of the first bar to a first neighbouring bar among the plurality of bars and the second dam extends from a second lateral side of the first bar opposite the first lateral side to a second neighbouring bar among the plurality of bars,
wherein the first dam is closest to the outer periphery among one or more dams extending from the first bar to the first neighbouring bar,
wherein the second dam is closest to the outer periphery among one or more dams extending from the first bar to the second neighbouring bar,
wherein the first bar comprises a bar section that extends between the first dam axis and the second dam axis,
wherein the bar section has a width in a width direction perpendicular to the first bar axis that is larger than a width in the width direction of a remainder of the first bar outside of the bar section.

2. The blade according to claim 1, the plurality of bars comprising one or more sets of bars, each set of bars comprising the first bar, the first neighbouring bar, and the second neighbouring bar.

3. The blade according to claim 2, wherein the plurality of bars and the plurality of dams are disposed in a plurality of pattern areas, wherein the pattern areas are positioned side by side with each other to cover at least a part of the blade surface, wherein each of the pattern areas comprises one or more of the one or more sets of bars.

4. The blade according to claim 2, wherein the sets of bars overlap with each other such that:
the first neighbouring bar of a first set of the one or sets of bars is also the first bar of a second set of the one or more sets of bars; and/or
the first neighbouring bar of the first set of the one or sets of bars is also the second neighbouring bar of the second set of the one or more sets of bars.

5. The blade according to claim 2, wherein the sets of bars overlap with each other such that:
the second neighbouring bar of the first set of the one or sets of bars is also the first bar of the second set of the one or more sets of bars; and/or
the second neighbouring bar of the first set of the one or sets of bars is also the first neighbouring bar of the second set of the one or more sets of bars.

6. The blade according to claim 2, wherein the sets of bars overlap with each other such that:
the first bar of the first set of the one or sets of bars is also the first neighbouring bar of the second set of the one or more sets of bars; and/or
the first bar of the first set of the one or sets of bars is also the second neighbouring bar of the second set of the one or more sets of bars.

7. The blade according to claim 2, wherein the sets of bars are adjacent to each other.

8. The blade according to claim 3, wherein the plurality of pattern areas comprise:
a first pattern area of bars and dams;
a second pattern area of bars and dams, wherein an orientation of the second pattern area is different from an orientation of the first pattern area, wherein the first and second pattern areas are positioned side by side with respect to each other to cover at least a part of the refining surface; and
one or more connecting bars and/or connecting dams connecting the respective bars and/or dams of the first pattern area and the second pattern area,
wherein the sets of bars of the first pattern area do not overlap with the sets of bars of the second pattern area.

9. The blade according to claim 1, wherein the plurality of bars is arranged such that a movement along the plurality of bar axes from the outer periphery to the inner periphery also a movement in a first circumferential direction.

10. The blade according to claim 1, wherein the plurality of dams is arranged such that a movement along respective dam axes of the plurality of dams from the inner periphery to the outer periphery is also a movement in the first circumferential direction, the plurality of dam axes comprising the first dam axis and the second dam axis.

11. The blade according to claim 1, wherein the first dam is closer to the outer periphery than the second dam.

12. The blade according to claim 1, wherein the second dam is closer to the outer periphery than the first dam.

13. The blade according to claim 1, wherein
the bar section comprises a first lateral edge and a second lateral edge opposite the first lateral edge; and
the first lateral edge is at least partially offset compared to a corresponding lateral edge of the remainder of the first bar relative to the first bar axis, or the second lateral edge is at least partially offset compared to a corresponding second lateral edge of the remainder of the first bar relative to the first bar axis.

14. The blade according to claim 13, wherein:
the first dam extends from the first lateral edge;
the second dam extends from the second lateral edge;
when the first lateral edge is offset, the second dam is closer to the outer periphery than the first dam; and
when the second lateral edge is offset, the first dam is closer to the outer periphery than the second dam.

15. The blade according to claim 1, wherein the bar section has a triangular shape when viewed from a direction perpendicular to the blade.

16. The blade according to claim 1, wherein the bar section comprises an inner end nearest the inner periphery and an outer end nearest the outer periphery, wherein the width of the bar section is larger at the inner end than the width of the bar section at the outer end.

17. The blade according to claim 1, wherein the bar section has a rectangular shape when viewed from a direction perpendicular to the blade.

18. The blade according to claim 1, wherein the bar section has one of a broken angle shape, a concave arc shape, a convex arc shape, a concave shape, and a convex shape when viewed from a direction perpendicular to the blade.

19. The blade according to claim 1, wherein:
each of the plurality of bar axes does not cross with another bar axis of the plurality of bar axes within the refining portion; and/or
each the plurality of dam axes does not cross with another dam axis of the plurality of dam axes within the refining portion.

20. A refiner for refining lignocellulosic material, comprising at least one blade according to claim 1.
